(19) United States
(12) Patent Application Publication
(10) Pub. No.: US 2005/0016352 A1
(43) Pub. Date: Jan. 27, 2005

(54) Handheld scoring device and method for scoring flexible sheet material

(76) Inventor: Ricky J. McCorkle, Matthews, NC (US)

Correspondence Address: Schwartz Law Firm, P.C.;SouthPark Towers, Suite 530, 6100 Fairview Road, Charlotte, NC, 28210, US

(21) Appl. No.: 10/671,852

(22) Filed: Sep. 26, 2003

Related U.S. Application Data
(60) Provisional application No. 60/489,431, filed on Jul. 23, 2003.

(51) Int. Cl. B26B 3/00; B26D 3/08

(52) U.S. Cl. 83/880; 30/317

(57) ABSTRACT

An improved method and apparatus for the cutting of inside 90-degree corners such as cabinet lining, wallpaper and the like is provided. The invention fits snugly into a 90-degree corner, and an internally contained razor blade depresses enough to cut the paper product desired. Sheet, film, or foil material is positioned or applied over the corner. The cutting device is then inserted firmly into the corner, and slide button 24 slid along a track in order to cut the paper the full length of the cutting device. If the length of the desired cut should exceed the cutting length of the device, the device can simply be moved, and the process repeated until the full piece of paper is cut.

### CROSS REFERENCE TO RELATED APPLICATION

This application claims the benefit of U.S. Provisional Application No. 60/489,431 filed on Jul. 23, 2003.

### BACKGROUND OF THE INVENTION

1) Field of the Invention

The present invention relates to a method and apparatus for the cutting of paper or paper like materials in the form of a film, sheet, or foil that have been applied to inside corners, such as in wallpaper, cabinet lining and vinyl flooring. More particularly, the present invention relates to a method and apparatus that allows the clean and safe cutting of inside 90-degree angles so that an appealing, professional look is obtained to the finished surface.

2) Background of the Invention

It is generally agreed that terminating wallpapers and other adhesive papers or tiles, such as shelving paper or liners and vinyl flooring, precisely where the wall or other surface abuts other adjacent structural members achieves the most aesthetically pleasing result. However, to achieve the best fit of the material, one cannot simply measure the height or width of the wall surface to be covered and cut a piece of wallpaper, liner paper or vinyl flooring to match.

Patterns of the most popular wallpapers must be aligned to hide the edges so that adjacent pieces appear to be continuous. Wallpaper expands when wetted, and then contracts on the wall as it dries, making precise alignment even more difficult. Additionally, walls that are not square with each other create obstacles to alignment that must be worked around.

Similarly, paper liners that are applied to the inside of drawers, and on cabinet shelves can be more precisely positioned if the cutting of the paper liner is done after the paper is applied to the surface. Paper cut prior to application usually does not fit squarely onto the desired surface due to measurement and installation errors by the user, or the stretching and mishandling to the paper liner. Paper that is cut in the drawer using methods known in the art usually results in damage to the drawer surfaces.

Vinyl flooring suffers from many of the same problems that were previously mentioned. Walls that are not square and operator error often result in a floor installation that leaves gaps and mismatches around the wall edges.

Therefore, most people who hang wallpaper, install vinyl flooring or apply paper liners do not try to precisely precut the paper and thereafter apply it to the wall or other surface. Rather, they find it advantageous to apply a piece of adhesive paper to the wall surface that overlaps onto the other structural members, such as floors, ceilings and adjacent walls, and then trim the excess paper. In this way, the paper can be adjusted on the wall to align with the patterns of adjacent wallpaper strips, and can best conform to the structural irregularities of the surface.

However, one is still left with the problem of removing the excess material that overlaps onto adjacent structural members. In order to achieve the desired uniform look to the paper, the paper should be cut as linearly as possible at the precise location where the paper covered surface meets adjacent structural members. This has traditionally been achieved by using a razorblade and a straight edge. The straight edge is positioned along the junction between the wall and the adjacent structural member. The razorblade is then run along the length of the straight edge, resulting in a uniform cut that fits snugly into the corner of the wall. In order to be used effectively, the straight edge has to be maintained at precisely the same location while the razor is drawn down the corner cutting the wallpaper. Too often this results in a cut that is not uniform due to slipping of the razor, the straightedge, or both. This can leave unsightly joints and unclean edges in the paper. An errant cut can leave scars in the walls and woodwork that often surround the newly covered area. Worse, a slipping of the razorblade can cause serious lacerations to the user that can require immediate medical attention.

When attempting to cut inside corners of liner paper using this method similar problems come up. Cabinets that are not square, paper that stretches and does not easily align properly, and errors by the installer all contribute to a final product that can appear second rate. Additionally, when working in the confined spaces inside the cabinetry, it is often difficult to correctly align a lengthy straight edge with a hard to reach inside corner. This problem gets compounded when the operator attempts to cut the paper. The tight area that the operator is working in, and the limited range of movement that is available, often result in the injuries that were described above.

What is therefore needed is a wallpaper, adhesive paper, vinyl cutting apparatus that is capable of making neat and clean cuts to materials that are applied to inside angles. Additionally, there is a need for an apparatus that is able to make these cuts while providing a level of safety that is not realized in the prior art.

### SUMMARY OF THE INVENTION

The present invention relates to a device that can be positioned into inside corners being able to easily and safely make a neat aesthetic cut that allows the paper to fit snugly into the inside corner.

The device is designed to cut inside corners, especially inside 90-degree corners that are encountered in such as applications as cabinet lining, wallpapering and the like. In that the invention fits snugly into a 90-degree corner, an internally held razor blade only depresses enough to cut the paper product desired. Additionally, the device can also be used as a standard utility knife.

To use the device, one simply positions the paper you would like to cut and press the device firmly into the corner and slide a slide button back along the grove. If the length of the cut should exceed the cutting length of the device, the device can simply be repositioned in the corner, and the process repeated until the full piece of paper is cut.

An easily removable end cap is provided to facilitate the changing of the cutting blade.

The device is very safe to use because of the inside corner closure and the fact that the blade only extends slightly from the device when the slide button is depressed.

These and other objects of the present invention are achieved in the preferred embodiments disclosed below by providing a handheld scoring device adapted for scoring flexible sheet material arranged at an inside corner defined by first and second converging surfaces. The device includes a housing having first and second converging sides adapted for engaging respective converging surfaces. The housing defines an interface at an intersection of the first and second sides for residing adjacent the inside corner. Means carried by the housing and adapted for protruding from the interface are provided to score the sheet material at the inside corner.

The term “sheet material” refers broadly to any flexible covering such as wallpaper, drawer and cabinet liners, films, foils, fabric and leather upholstery, vinyl flooring, carpeting, and the like. The term “scoring” is also defined broadly herein to mean any marking, such as with lines, grooves, scratches, notches, cuts, or perforations, and including any degree of surface penetration, such as a complete cut through the sheet material. The “means” for scoring may comprise any suitable cutting or perforation blade, or surface marking element.

### BRIEF DESCRIPTION OF THE DRAWINGS

The foregoing and other objects will become more readily apparent by referring to the following detailed description and the appended drawings in which:

FIG. 1 is an isometric view of the cutting device consistent with the preferred embodiment of the present invention.

FIG. 2 is a cross sectional view of the cutting device showing the slide button in the released configuration consistent with the preferred embodiment of the present invention.

FIG. 3 is a cross sectional view of the cutting device showing the slide button in the depressed configuration consistent with the preferred embodiment of the present invention.

FIG. 4 is an isometric view of the top surface of the cutting device consistent with the preferred embodiment of the present invention.

FIG. 5 is a cross sectional view of the cutting device depicting a profile view of the slide assembly consistent with the preferred embodiment of the present invention.

FIG. 6 is cross sectional view depicting the cutting device of the present invention properly positioned in an inside 90-degree corner, and engaged in the cutting of paper materials therein, consistent with the preferred embodiment of the present invention.

FIG. 7 is a perspective view of the cutting device consistent with the preferred-embodiment of the invention, used in conjunction with a cutting brace.

### DESCRIPTION OF THE PREFERRED EMBODIMENTS

Applicant is not aware of any prior art that gives the clean quality cuts to inside corners that are achievable with the current invention. Additionally, the level of safety that is achieved by the current invention is unmatched by any of the prior art solutions.

The cutting device is preferably made having a plastic housing with a metal or alloy slide assembly, but other materials can be used as are generally known in the art.

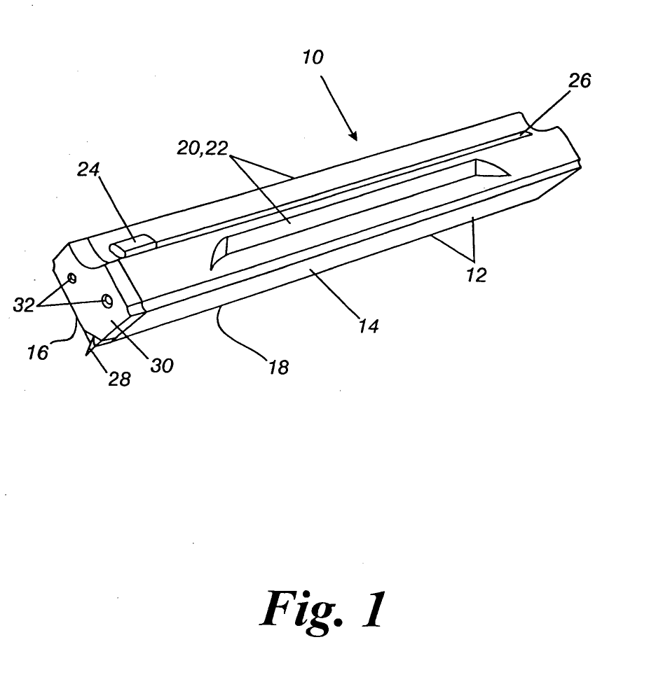

Referring now to FIG. 1, the cutting device 10 of the present invention is contained within a housing 12. The housing 12 is constructed having a first side 14 and a second side 16 that come together at a first interface 18. The first and second sides (14 and 16) preferably come together at the first interface 18 to form a 90-degree angle, thus allowing the cutting device 10 to fit snugly into an inside 90-degree corner. In an alternative embodiment, the sides 14, 16 of the housing 12 may be rounded to match the contours of a rounded inside corner. The cutting device 10 is aligned so that the first interface 18 is coaxial with the vertex of the inside angle; the first and second sides 14 and 16 of the cutting device 10 are abutted against the two adjoining walls or surfaces. Two contoured finger grips 20 and 22 are preferably provided for ease in maneuvering the cutting device 10 into and out of inside corners.

Opposite the first interface 18, there is provided a slide button 24. This slide button 24 is located along a slide guide 26 that is situated parallel to the first interface 18. The slide button 24 is capable of longitudinal movement along the slide guide 26. This longitudinal movement of the slide button 24 controls a cutting means 28 that is located within the housing 12, and protrudes slightly therefrom at the first interface 18. Preferably, the cutting means 28 is a razorblade, but other devices that are capable of easily cutting a piece of wallpaper, film, sheet, foil or the like can be substituted. A longitudinal movement of the slide button 24 produces a corresponding longitudinal movement of the cutting means 28. In this way, a user of the present invention is able to make precise cuts to material lined inside corners without the cutting means 28 coming into proximity of the user's fingers.

Additionally, the slide button 24 can be-configured so as to be capable of depressible movement, with a corresponding extension of the cutting means 28. When the slide button 24 is released, that is not in the depressed configuration, the cutting means 28 is retracted into and contained entirely within the housing 12.

At one end of the housing 12 is provided an end cap 30 that is removably attached to the housing 12. This is preferably done by way of two screws 32 but other means that are known in the art that are capable of releasably securing the end cap to the housing, such as expansion clips, tab inserts or the like can also be used. The end cap 30 is provided so as to allow access to the cutting means 28 contained within the housing 12. By removing the end cap 30, a user can replace just the cutting means 28 that has been dulled, or broken without having to throw out the entire cutting device 10.

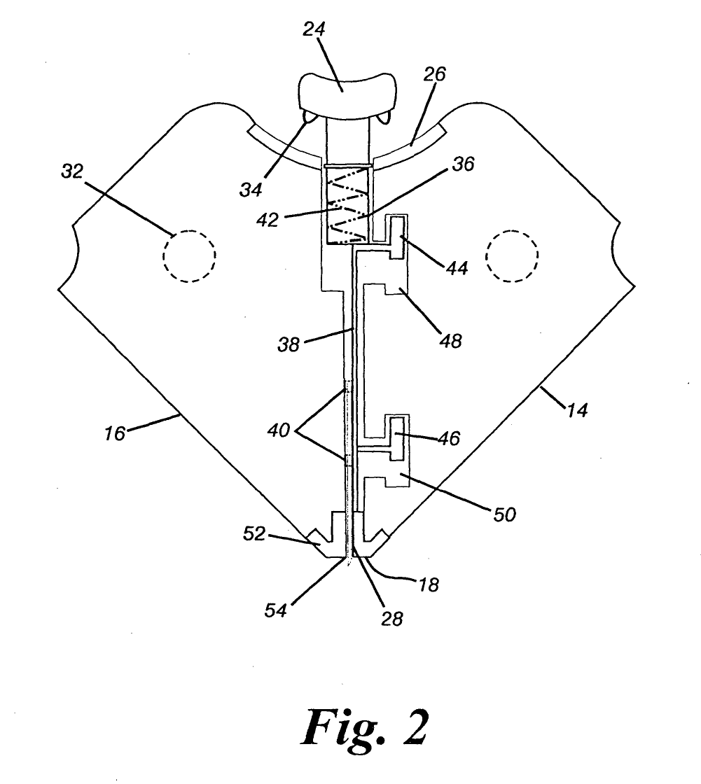

FIG. 2 depicts an enlarged cross-sectional view of the current invention with the slide button 24 in the released configuration. Located on the lower surface of the slide button 24 is a plurality of beveled bumps 34. These beveled bumps 34 contact the slide guide 26 when the slide button 24 is depressed, and prevent the edges of the slide button 24 from becoming snagged, or otherwise caught in the slide guide 26. The beveled bumps 34 thereby facilitate the longitudinal movement of the slide button 24 along the slide guide 26. Alternatively, the beveled bumps 34 could be made of a reduced friction material, making longitudinal movement of the slide button 24 even easier.

Extending from the bottom of the slide button 24, through the slide guide 26, and into the housing 12 is a shaft 36. The shaft 36 connects the slide button 24 to a connecting plate 38, which allows for the control of the cutting means 28. The connecting plate 38 extends through the interior of the housing 12 and is connected to the cutting means 28 by way of two dowels 40 integrally attached to the connecting plate. Thus, when the slide button 24 is depressed, the cutting means 28 correspondingly extends from the first interface 18. Likewise, a longitudinal movement of the slide button 24 produces a corresponding movement of the cutting means 28 along the first interface 18.

Preferably, a spring mechanism 42 is located about the shaft 36 just inside the housing 12. The spring mechanism 42 maintains the slide button 24 in the released configuration, and therefore also maintains the cutting means 28 in a withdrawn position inside the housing 12. The cutting device 10 therefore will remain in this released configuration, preventing an inadvertent accident due to an exposed razorblade that can occur with other cutting devices that are known in the art. While the cutting device 10 would function without the spring mechanism 42, this is not preferred, since the cutting means 28 would not be retained in the released configuration when the slide button 24 is not depressed and the cutting device 10 is not in use.

Contained within the housing 12, and extending from the connecting plate are upper and lower beveled guides 44 and 46. The beveled guides 44 and 46 slide within corresponding upper and lower channel guides 48 and 50. The movement of the beveled guides 44 and 46 is confined to a slight depression, and then sliding within their corresponding channel guides 48 and 50, so that the controlling movement of the slide button/connecting plate/cutting means assembly is correspondingly restricted to longitudinal linear movement. Additionally, the channel guides 48 and 50 restrict the extension of the cutting means 28, so that cutting is limited to only the liner material, and will not mar adjacent structural surfaces. This is accomplished by configuring the channel guides so that the cutting means is allowed to extend to the limit of, but will not protrude beyond the angle formed by the first and second sides.

The first interface 18 is preferably capped with a metal or metal alloy bottom 52 to increase the durability of the cutting device. The metal bottom 52 is provided with a cutting channel 54. The cutting means 28 extends from, and slides along the cutting channel when a corresponding movement is made with the slide button 24. When the slide button 24 is depressed, the cutting means 28 extends out of the housing 12 through the cutting channel. The slide button 24 can then be moved longitudinally along the slide guide 26, which causes the protruding cutting means 28 to correspondingly slide along the cutting channel 54, thus cutting any paper material that is proximately situated.

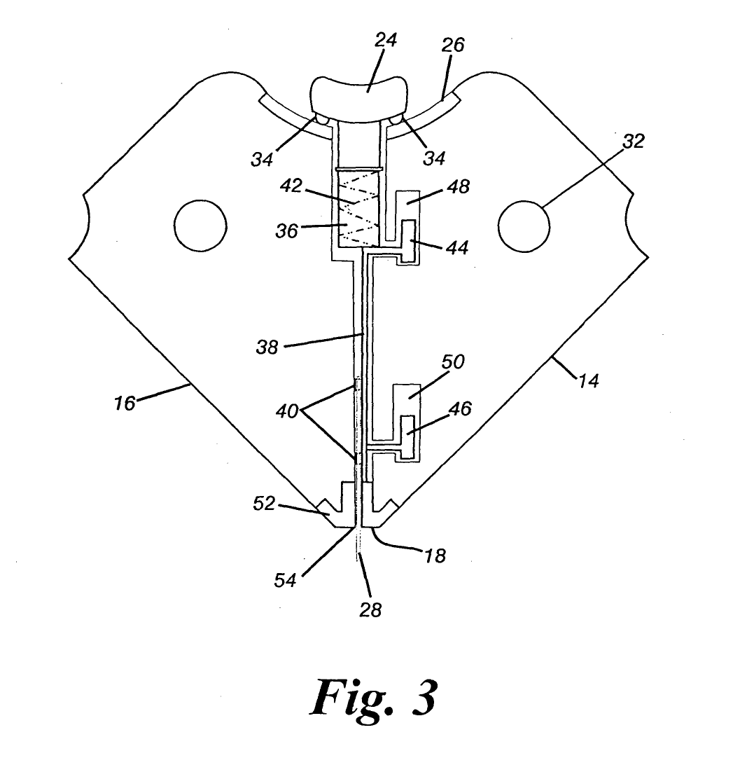

FIG. 3 depicts an enlarged cross-sectional view of the current invention with the slide button 24 in the depressed configuration. The slide button 24 has been depressed so that the beveled bumps 34 are in contact with the slide guide 26. The upper and lower beveled guides 44 and 46 have also moved down from their released positions so that they now are engaged with the upper and lower channel guides 48 and 50, allowing for easy slidable motion of the slide button/connecting plate/cutting means assembly. The cutting means 28 has also extended out from the housing 12, through the cutting channel 54, and is ready to engage paper materials for the cutting. In the preferred embodiment, the cutting means should only extend from the housing about ⅛ inch. This extension is enough to completely engage and cut any adjacent sheet material, but at a distance of only ⅛ inch, the risk of serious harm to the user is greatly decreased. It should be noted that the extension distance of the cutting means can be varied in the manufacturing of the cutting device, so that the cutting means is capable of extending further from the housing, such as ¼ or ⅜ inch, depending on the desired application of the cutting device, the thickness of the material to be cut, and the proximity of the cutting device to the adjacent structural members so as to prevent the marring thereof.

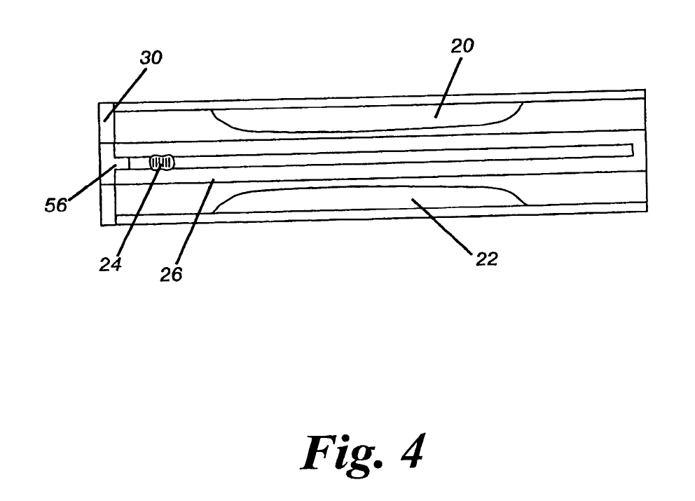

FIG. 4 depicts a top view of the current invention. It can here be seen that the end cap 30 is preferably configured so as to have a stop 56 that extends from the end cap into the slide guide 26. This provides a convenient forward stopping point for the slide button/connecting plate/cutting means assembly, and prevents the cutting means 28 from damaging the inner surface of the end cap 30.

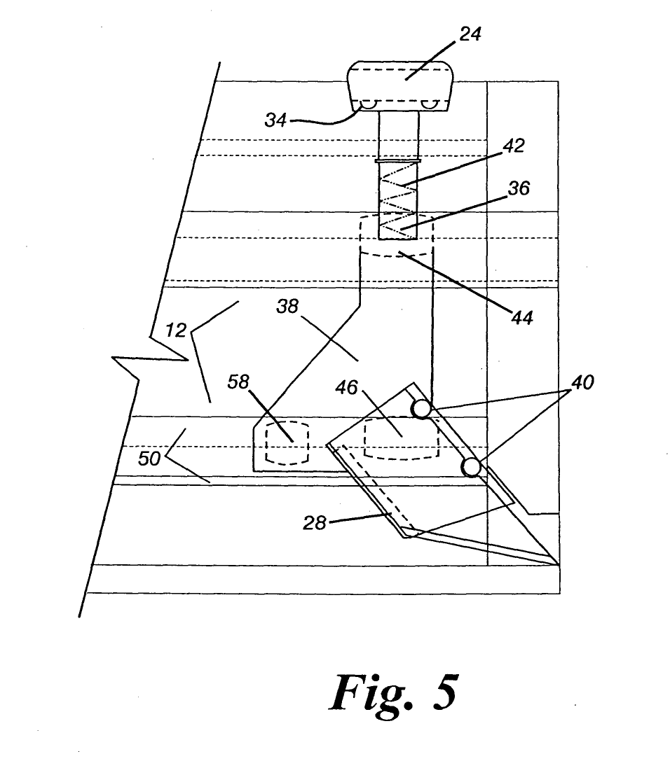

FIG. 5 depicts a cross sectional view of the cutting device, showing a profile of the slide button/connecting plate/cutting means assembly. It can be seen that the slide button/connecting plate/cutting means assembly is preferably shaped so as to have a back beveled guide 58. This back beveled guide is collinear with the lower bevel guide and preferably slides along the same lower channel guide as the lower bevel guide. By creating these two contact points on the same lower channel, unwanted rocking or tilting of the slide button/connecting plate/cutting means assembly within the housing 12 is thereby eliminated. This results in the smooth operation of the slide button/connecting plate/cutting means assembly. This elimination of a rocking motion could also be achieved in an embodiment were the back bevel guide was contained within its own channel guide, so long as the back bevel is located distal to the upper and lower bevels.

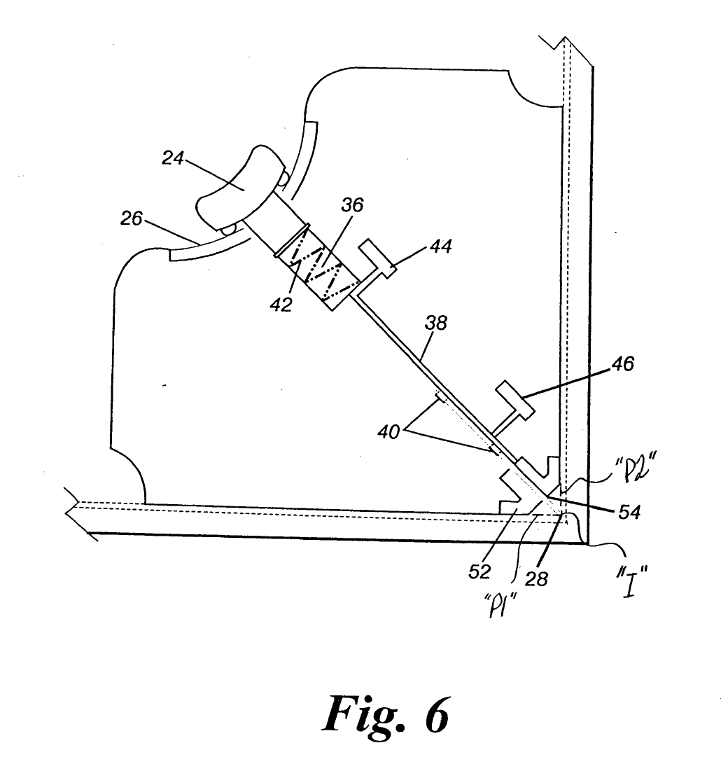

FIG. 6 depicts a cross sectional view of the cutting device engaged in cutting a paper material that has been applied to an inside 90-degree corner. Note that the slide button 24 is in the depressed configuration, so that the cutting means 28 is extended and engaged with the paper material. In this position, the cutting means 28 does not protrude beyond a point of intersection “I” of notional planes “P1” and “P2” defined by respective sides 14, 16 of the housing 12. While the cutting means 28 is sufficiently extended to cut the paper material, the underlying substrate is protected against any potential over-cut damage.

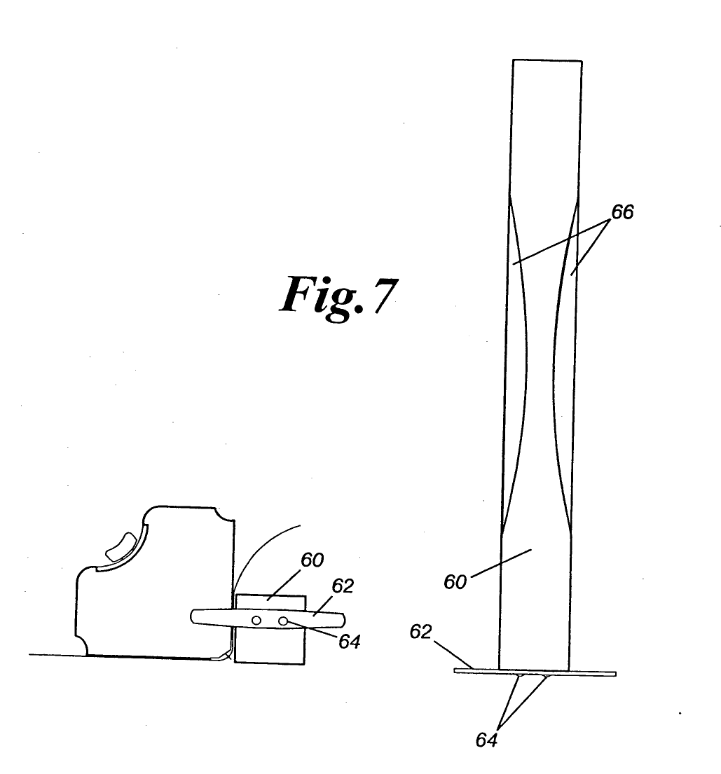

FIG. 7 depicts a perspective view of an optional cutting brace 60 that can be used in conjunction with the cutting device. The cutting brace 60 is preferably formed from a wooden block, but can also be made of metal, metal alloys, or plastics. When the cutting brace 60 is used in conjunction with the cutting device, the cutting brace 60 effectively takes the place of an adjacent structural member, thus allowing the cutting device to make clean cuts of materials that are not fitted into inside corners. The cutting brace 60 is positioned firmly atop the papered surface. Preferably, two finger grips 66 facilitate this positioning by the user. In this configuration, the cutting brace surfaces perpendicular to the papered surface form an inside 90-degree angle with the papered surface. The cutting device can then be fitted into this newly formed, temporary inside 90-degree angle, and the paper material can be cut utilizing the preferred method. Preferably, the cutting brace 60 has a stop plate 62 attached at one end of the brace by way of connecting pins 64. The brace is preferably made of metal, but other materials such as plastics, metal alloys, or wood are also contemplated. The stop plate 62 provides a convenient surface that the cutting device can be situated against, ensuring that paper material is cut on a straight line, parallel with the placement of the cutting brace 60, and perpendicular to the stop plate 62.

In use, the cutting apparatus 10 is situated into an inside corner that has been lined with a sheet, film, or foil material. The cutting device 10 is pressed firmly into the corner, so that the liner material is snugly situated against the adjacent lined surface and the adjacent wall with only the ⅛ to ¼ inch of liner material closest to the corner not being flush against the lined surface. The first interface region engages the liner material in such a way that the liner material fits snugly around the body of the cutting device, while leaving a small area proximate to the wall corner and the first interface into which the cutting device can extend without actually coming into contact with the lined surface or adjacent structures. The slide control button 24 on the cutting device 10 is depressed, thus extending the cutting means 28 and engaging it with the liner material. The slide control button 24 is then moved along the slide guide 26 so that a cut the length of the apparatus is made in the liner material. When the cut is finished, the slide control button 24 is released from its depressed orientation. Being spring mounted, the slide control button 24 then returns to the released orientation, simultaneously retracting the cutting means 28 back into the housing 12 of the cutting device 10.

Thus it has been apparent that there has been provided, in accordance with the invention, a device for safely cutting paper materials that have been applied to inside angles that fully satisfies the objects, aims, and advantages set forth above. While the invention has been described in conjunction with specific embodiments thereof, it is evident that many alternatives, modifications, and variations will be apparent to those skilled in the art in light of the foregoing description. Accordingly it is intended to embrace all such alternatives, modifications, and variations as fall within the spirit and broad scope of the appended claims.

1. A handheld scoring device adapted for scoring flexible sheet material arranged at an inside corner defined by first and second converging surfaces, said scoring device comprising:
(a) a housing having first and second converging sides adapted for engaging respective converging surfaces, and defining an interface at an intersection of said first and second sides for residing adjacent the inside corner; and
(b) means carried by said housing and adapted for protruding from said interface to score the sheet material at the inside corner.

2. A handheld scoring device according to claim 1, wherein said scoring means is slidably mounted within said housing and adapted for longitudinal movement along a length dimension thereof.

3. A handheld scoring device according to claim 2, and comprising a user-actuated slide control button connected to said scoring means and adapted for moving said scoring means along the length dimension of said housing.

4. A handheld scoring device according to claim 3, wherein said housing defines a longitudinal guide track opposite said interface, and adapted for guiding longitudinal movement of said slide control button.

5. A handheld scoring device according to claim 4, wherein said slide control button comprises beveled bumps extending proximate to said guide track to facilitate longitudinal movement of said control button.

6. A handheld scoring device according to claim 1, and comprising biasing means for normally urging said scoring means into a retracted condition within said housing.

7. A handheld scoring device according to claim 1, and further comprising an end cap removably attached to said housing to facilitate access to said scoring means therein.

8. A handheld scoring device according to claim 1, wherein said housing comprises contoured finger grips.

9. A handheld scoring device according to claim 1, wherein said interface defines a rounded edge of said housing.

10. A handheld scoring device according to claim 1, wherein the first and second sides of said housing are disposed at a substantially 90-degree angle.

11. A handheld scoring device according to claim 1, wherein said housing comprises a length dimension and a width dimension, the length dimension being greater than three times the width dimension.

12. A handheld scoring device according to claim 1, wherein the length dimension of said housing is greater than 6 inches.

13. A handheld scoring device according to claim 1, wherein said means for scoring comprises a knife.

14. A method of scoring flexible sheet material, comprising the steps of:
(a) arranging the sheet material at an inside corner defined by first and second converging surfaces;
(b) locating a cutting device adjacent the inside corner and over the sheet material, the cutting device having first and second converging sides adapted for engaging respective converging surfaces, and defining an interface at an intersection of the first and second sides; and
(c) extending a scorer from the interface of the cutting device to score the sheet material at the inside corner.
